(19) United States
(12) Patent Application Publication
(10) Pub. No.: US 2013/0181416 A1
(43) Pub. Date: Jul. 18, 2013

(54) TARPAULIN HAULING DEVICE

(71) Applicant: Brian Keith Ross, Orlando, FL (US)

(72) Inventor: Brian Keith Ross, Orlando, FL (US)

(21) Appl. No.: 13/352,506

(22) Filed: Jan. 18, 2012

(51) Int. Cl. B62B 15/00

(52) U.S. Cl. 280/18

(57) ABSTRACT

A tarpaulin has a forward hauling rig comprising a light weight bar attached to and reinforcing the forward edge. A rigid metal hauling bar is connected by springs to the forward edge. A hauling rig has a chain and steel ring which attaches to a motorized lawn mower or tractor for hauling. An extension hauling rig has a hook attached to the ring and another chain and ring which attaches to a belt worn by an animal or person for hauling. Elongated elements at a back end of the tarpaulin form the back end into a funnel tube for emptying the tarpaulin.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to hauling devices and in particular to a hauling tarpaulin having a semi-rigid bar attached to the front edge of the tarpaulin to keep it flat while loading and hauling and a steel hauling bar attached to the front edge by springs and a hauling rig in front with a ring to attach to a vehicle and an extension hauling rig to attach to a belt worn by an animal or person for hauling, the tarpaulin further comprising at back end a series of transverse spaced flexible flat bars for maintaining the tarpaulin flat during loading and hauling and for bending into circles to form a funnel tube for unloading the tarpaulin.

2. Description of Related Art Including Information Disclosed Under 37 CFR 1.97 and 1.98

Disposing of a large quantity of leaves or other dispersed matter takes a long time and many trips in a conventional wheel barrel or other conventional containers. Prior art tarpaulins can wrap up the leaves or other matter, but are difficult to move due to the awkward shape and sometimes heavy weight and lack of easy gripping means when loaded.

U.S. Pat. No. 2,974,971, issued Mar. 14, 1961 to Buck, indicates a pick-up device for hauling leaves, etc, which has a two-handed pull handle and end ground spikes.

U.S. Pat. No. 5,104,133, issued Apr. 14, 1992 to Reiner, puts forth a hauling device for leaves, litter, and other materials such as stone, earth, mulch, manure and tree stumps comprises a tarpaulin with flexible support members and a rope including a unique assembly whereby the operator may secure and haul the collected material by pulling a loop of the rope. The tarpaulin is fitted with flexible support members within hems along the rear side edge and along a portion of each side edge. The rope ends are attached to the tarpaulin at both sides and threaded through the apertures of hardware located at both front and rear corners, thus providing a loop along the front side to be grasped either by the operator or a mechanical device such as a tractor. Once material is collected on the surface of the tarpaulin, the operator pulls the loop and thereby harnesses the rear and side edges, flexes the support members, and in unison confines the collected material. As the operator continues to pull the loop, obstructions on the rope arrest the confining action to provide a towline for the operator to haul the device along the ground to another location. To unload the material, the operator releases the loop and grasps the device along the rear side and rolls out the material over the front side. After the device is free of material, the operator gives the device a shake which retracts the rope and provides the device in a flat state to position for another load of material.

U.S. Pat. No. 5,660,402, issued Aug. 26, 1997 to Jones et al, describes a tarp which may be pulled along the surface of the ground by hand, or while being attached behind a motorized vehicle, and used for expeditiously carrying a variety of objects which collectively would be too heavy or too awkward to carry in one's arms. The tarp has a hemmed perimeter, corner reinforcing pieces, at least one reinforced area attached to its bottom surface, a plurality of eyelets attached to the hemmed perimeter, and telescoping support bars positioned within the hemmed perimeter to evenly distribute pulling forces along the leading edge of the tarp. Applications may include, but are not limited to, use behind motorized vehicles such as tractors, lawn tractors, all terrain vehicles, snow mobiles, golf carts, truck, and automobiles, for residential, commercial, industrial, and agricultural purposes.

U.S. Pat. No. 5,709,477, issued Jan. 20, 1998 to Schinasi et al, is for a device for the collection and transport of garden refuse, consisting of a lower piece (2), made for preference of a sliding material, in such a way that its two faces which are capable of sliding present a low coefficient of friction, the device thus resembling a bag, in such a way that the lower piece (2) comprises a broad sheet (7) capable of being folded back onto the bag in such a way as to bring together the handling grips (8 and 9). The device not only allows or garden refuse to be collected and moved, by dragging it like a sled, but likewise allows for the bag to be closed on itself in such a way as to allow or clean and practical transport of the refuse.

U.S. Pat. No. 6,565,101, issued May 20, 2003 to Jones et al, discloses a hauling tarpaulin which can be deployed, loaded with refuse, moved and unloaded by a single person. A stored tarpaulin rolled about a mandrel is easily unrolled and filled with lawn refuse. The mandrel holds the tarpaulin flat on the ground despite wind. When the hauling tarpaulin is filled with refuse, the hauling line is pulled, causing the mandrel to rise up on its legs, and the sides to rise, forming a boat-shaped structure which engulfs the refuse. The hauling tarpaulin then is pulled by the hauling line to the refuse collecting point. At the collecting point the tarpaulin is restored to its flat form and the waste material unloaded.

What is needed is a tarpaulin that can be piled with leaves or other matter for hauling with an easily attachable stable hauling rig which maintains the tarpaulin substantially on the ground while hauling and a rig which is easily attached to a tractor or a belt for easy hauling and which provides a means for easily emptying the tarpaulin in an organized fashion.

### BRIEF SUMMARY OF THE INVENTION

An object of the present invention is to provide a tarpaulin with a semi-rigid bar attached to a front edge to maintain the tarpaulin flat and a forward hauling rig comprising a rigid bar connected with springs to the forward edge of the tarpaulin, the second bar having a hauling rig which attaches to a vehicle or, with an extension, to a belt for hauling, wherein the tarpaulin can be piled with leaves or other matter for hauling with an easily attachable stable hauling rig which maintains the tarpaulin substantially on the ground while hauling and a rig which is easily attached to a tractor or a belt for easy hauling and at least two flexible transverse rods at the back of the tarpaulin which bend into circles to create a funnel tube at the back of the tarpaulin and a series of rigid rods removably inserted in spaced sleeves positioned perpendicularly between each adjacent pair of elongated rods to maintain a stable funnel tube to provide a means for easily emptying the tarpaulin in an organized fashion.

In brief, the present invention provides a tarpaulin hauling device having a front edge semi-rigid bar and back spaced flexible bars for maintaining the tarpaulin flat during loading and hauling and a rigid bar attached by springs to the front edge and a hauling rig attached to the rigid bar for easy hauling of the tarpaulin.

The flexible bars forming circles at the back of the tarpaulin form a funnel tube for easy and orderly unloading of the tarpaulin.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a plan view showing the hauling tarpaulin of the present invention laid out flat for loading and hauling and showing a hauling ring and hauling bar removably attached by springs and hooks or clamps to the front edge of the tarpaulin and further showing transverse bendable elongated members in permanent pockets with end snaps and a series of removable rigid rods extending perpendicularly between the elongated members adjacent to a back edge of the hauling tarpaulin wherein the hauling ring of the hauling rig may be attached to a driven lawn mower, tractor, or other vehicle to haul a loaded tarpaulin or alternately attached to the extension ring, chain, and hook for use with a belt worn by an animal or person to haul a loaded tarpaulin;

FIG. 2 is a plan view showing the hauling tarpaulin of FIG. 1 having the spaced transverse elongated members at the back of the tarpaulin each curved into a temporary circle with the two overlapping ends snapped together to form a funnel tube having a series of removable rigid rods extending between the elongated members for rigidity at the back of the tarpaulin for emptying the tarpaulin into a cinch tie bag, as shown, or into any other container, hauling vehicle, compost storage, incinerator, or just a neat pile;

FIG. 3 is a plan view showing the hauling tarpaulin of the present invention laid out flat for loading and hauling and showing a hauling ring and hauling bar removably attached by springs and hooks or clamps to the front edge of the tarpaulin and further showing transverse bendable elongated members in permanent pockets with end mating buttons and loops and a series of removable rigid rods extending perpendicularly between the elongated members adjacent to a back edge of the hauling tarpaulin wherein the hauling ring of the hauling rig may be attached to a driven lawn mower, tractor, or other vehicle to haul a loaded tarpaulin or alternately attached to the extension ring, chain, and hook for use with a belt worn by an animal or person to haul a loaded tarpaulin;

FIG. 4 is a plan view showing the hauling tarpaulin of FIG. 3 having the spaced transverse elongated members at the back of the tarpaulin each curved into a temporary circle with the two overlapping ends buttoned together to form a funnel tube having a series of removable rigid rods extending between the elongated members for rigidity at the back of the tarpaulin for emptying the tarpaulin into a tie bag, as shown, or into any other container, hauling vehicle, compost storage, incinerator, or just a neat pile;

FIG. 5 is a perspective view showing the hauling ring and hauling bar removed from the front edge of the hauling tarpaulin for storage and the hauling tarpaulin of the present invention rolled up for storage and showing an external pocket on the rolled up hauling tarpaulin for storing the removable rigid rods so that the hauling tarpaulin rolls up easily and compactly for storage.

### DETAILED DESCRIPTION OF THE INVENTION

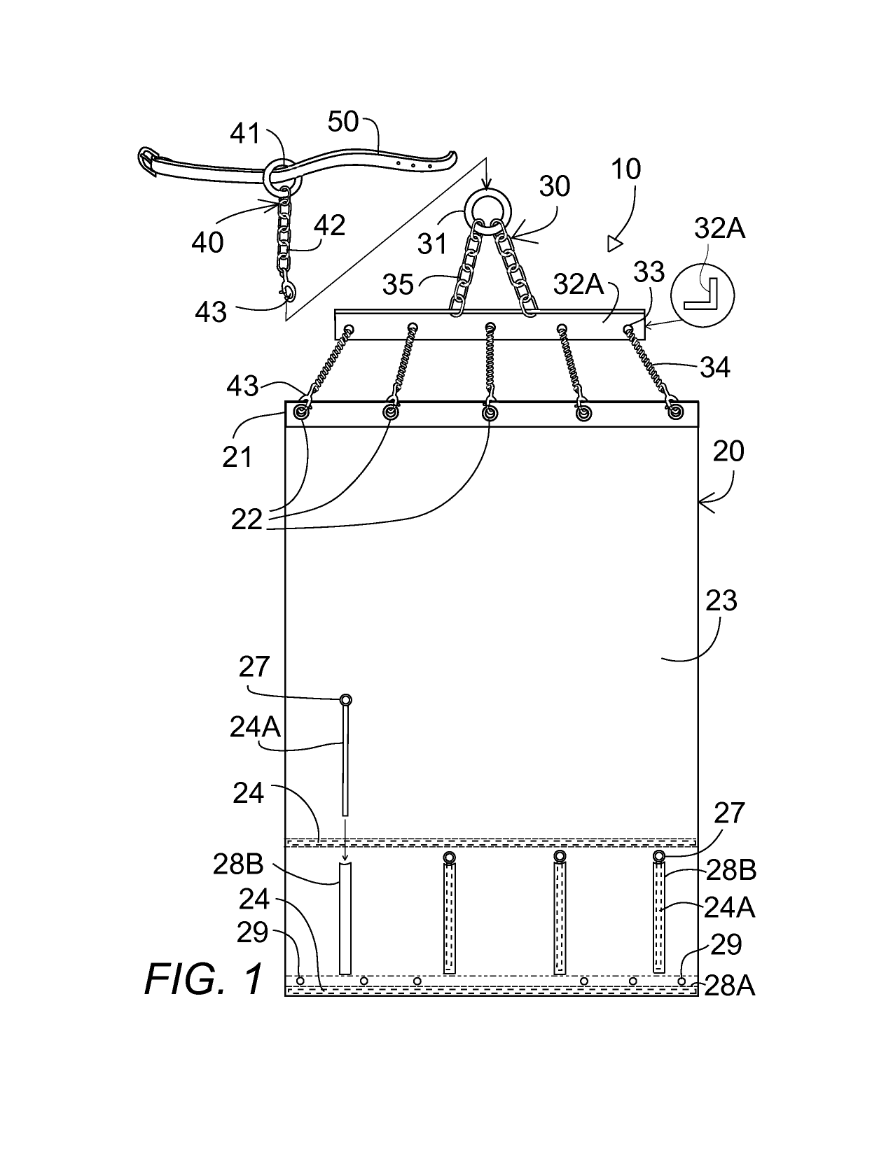

In FIGS. 1-5, a tarpaulin hauling device 10 comprises a flat tarpaulin 20 for loading and hauling leaves and other loose materials and a hauling rig 30 secured to the front of the tarpaulin.

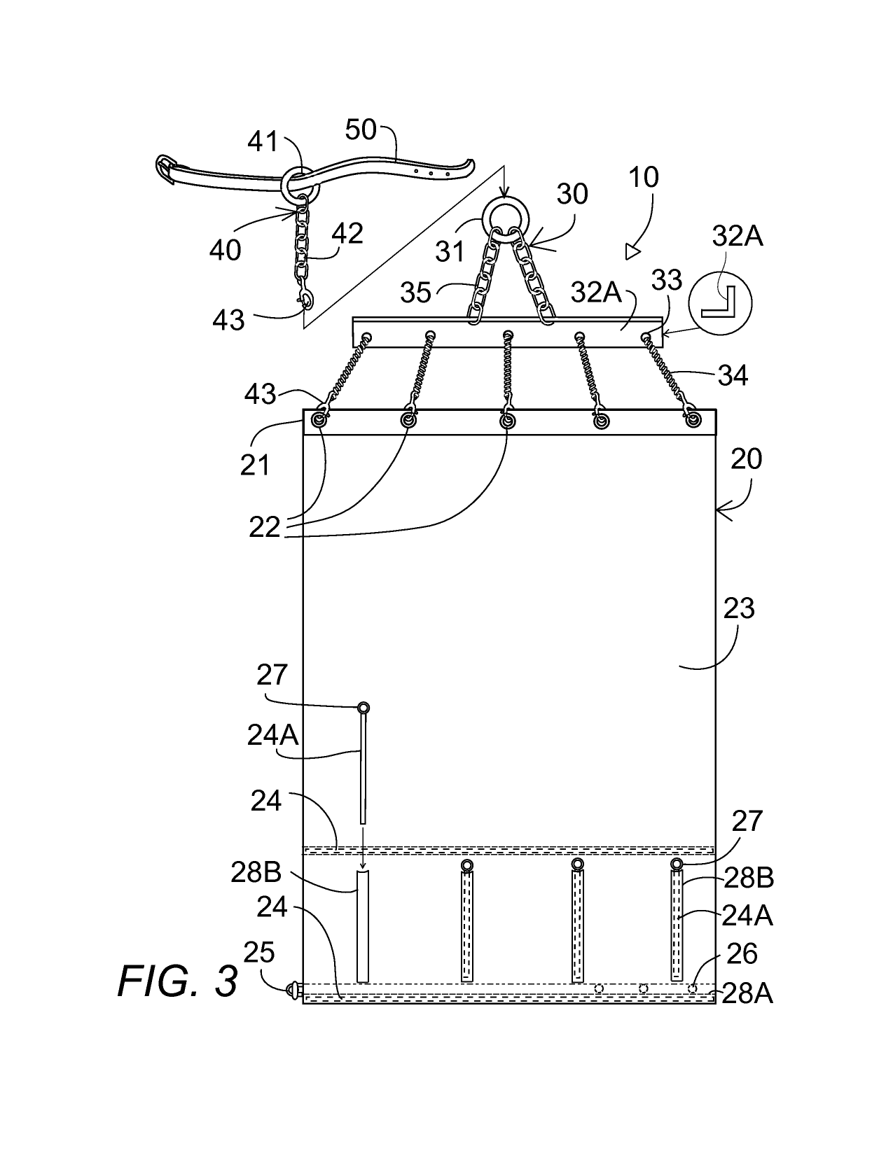

The tarpaulin 20 comprises a planar flexible fabric 23 for transporting materials over ground, as shown in FIGS. 1 and 3. A semi-rigid edge strip 21 attached to a front edge of the tarpaulin enables the front edge to travel over the ground smoothly while maintaining the integrity of the edge. A rigid forward hauling bar 32A, preferably an angle iron as illustrated, is attached to the semi-rigid strip of material 21 on the front edge by springs 34 to provide flexibility of movement therebetween so that the forward edge of the tarpaulin remains on the ground and the tarpaulin remains flat during towing. The hauling bar 32 is spaced apart from and parallel to the front edge of the tarpaulin. A hauling rig 30 is attached to the hauling bar 32 to enable the hauling bar to be attached to a moving body to haul the tarpaulin over the ground. In FIG. 1, the hauling bar 32 is a flat metal bar and the hauling bar 32A, as shown in the plan view and exploded side view of FIGS. 1 and 3, is a metal angle bar for extra strength.

The semi-rigid edge strip 21 along the front edge preferably comprises a bar of strong resilient material, which may be a synthetic material such as nylon or plastic or a flexible metal bar, having a series of spaced grommets 22 along the length for removably attaching the springs 34 thereto from the towing bar 32, preferably with a locking hook 43 at the end of each spring 34 attaching to one of the grommets 22.

The towing bar 32 comprises a rigid metal bar having a series of spaced openings 33 along the length of the metal bar for receiving the springs 34 and the hauling rig 30 attached to the metal bar.

The hauling rig 30 comprises an elongated flexible hauling element, preferably a chain 35, having at least one circular ring 31, preferably a steel ring, attached thereto for attaching to a moving body, such as a motorized lawn mower or tractor or recreational vehicle for hauling the tarpaulin.

In FIGS. 1 and 3, a hauling extension 40 comprises an additional circular ring 41, preferably a rigid steel ring with an associated chain 42 and hook 43 to attach to the hauling rig ring 31 to attach the additional circular ring 41 to a belt 50 worn by an animal or a person for hauling the tarpaulin.

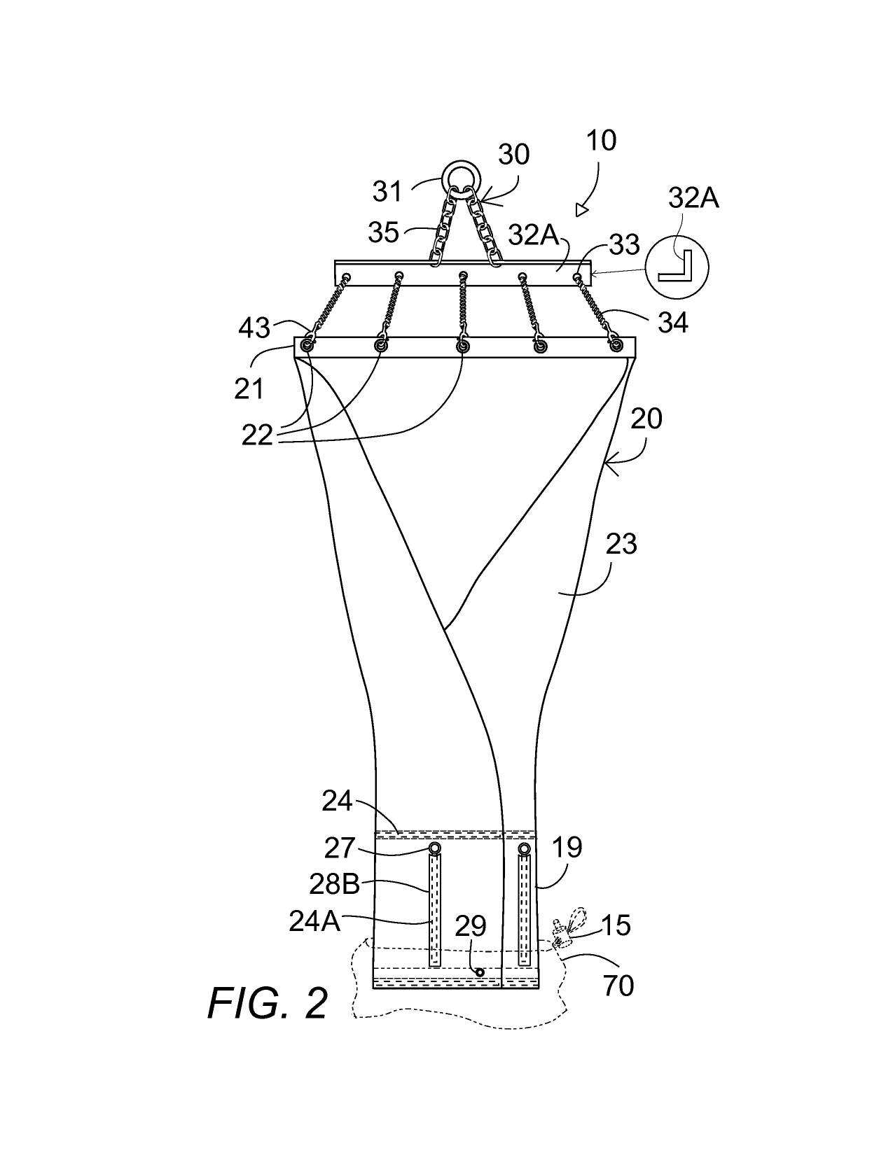

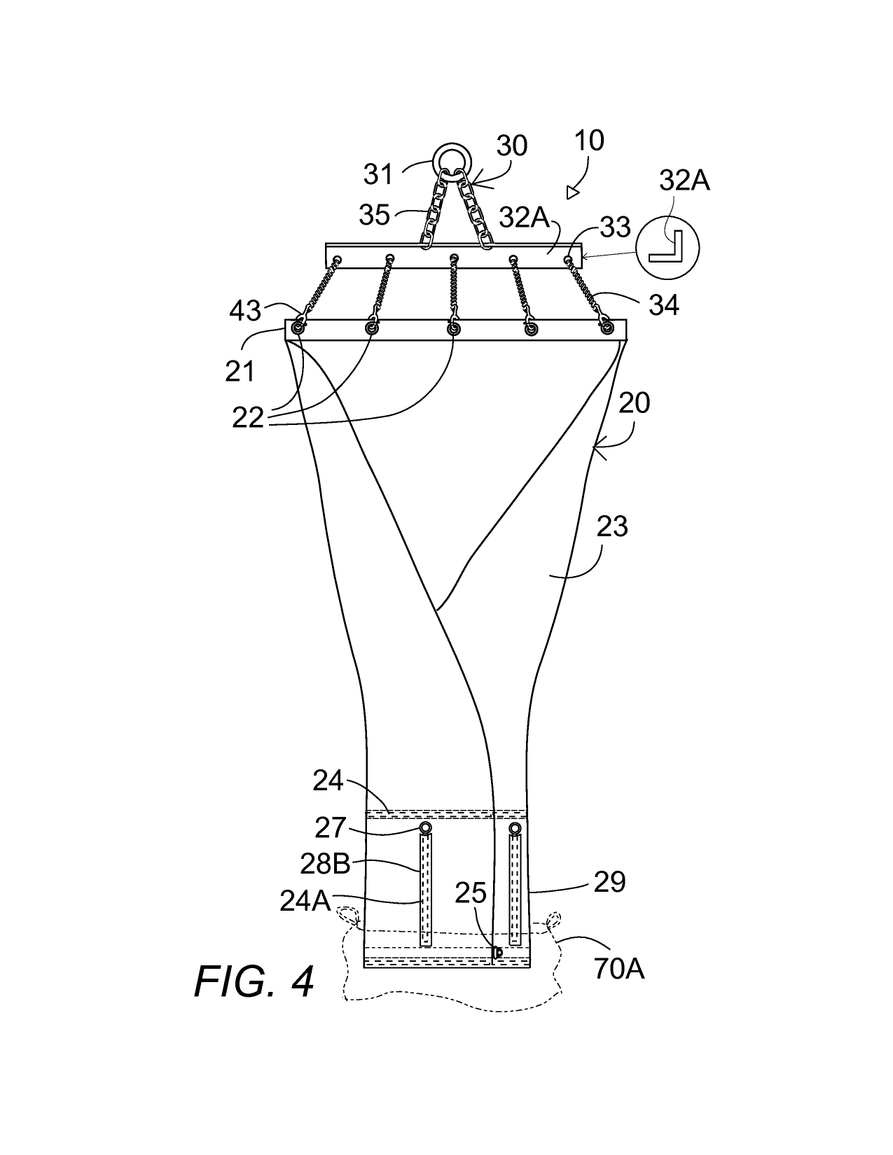

At least two flexible elongated members 24 are attached in permanently sewn-in sleeves 28A transversely across the tarpaulin fabric 23 from a back edge of the tarpaulin forward in spaced parallel alignment. A mating connector is attached to the tarpaulin 20 at each end of each of the elongated members 24, the connector comprising at least one snap component 29 at one end and a series of mating snap components 29 at an opposite end for adjustability, as shown in FIGS. 1 and 2, or a cinch loop 25 at one end and a series of mating buttons 26 at an opposite end for adjustability as shown in FIGS. 3 and 43. Each of the elongated members 24 is normally positioned flat on the flat tarpaulin in a first position, as shown in FIGS. 1 and 3, for maintaining the back of the tarpaulin in a flat position during loading and hauling the tarpaulin 20. Each of the elongated members 24 is positioned into a circular loop in a second position, as shown in FIGS. 2 and 4, with the mating connectors at each end removably connected together to form the tarpaulin into a tubular funnel shape 29 at the back of the tarpaulin for unloading the tarpaulin. The adjustability of the end connectors enables forming funnel tubes 29 of varying diameters depending on the intended unloading procedure.

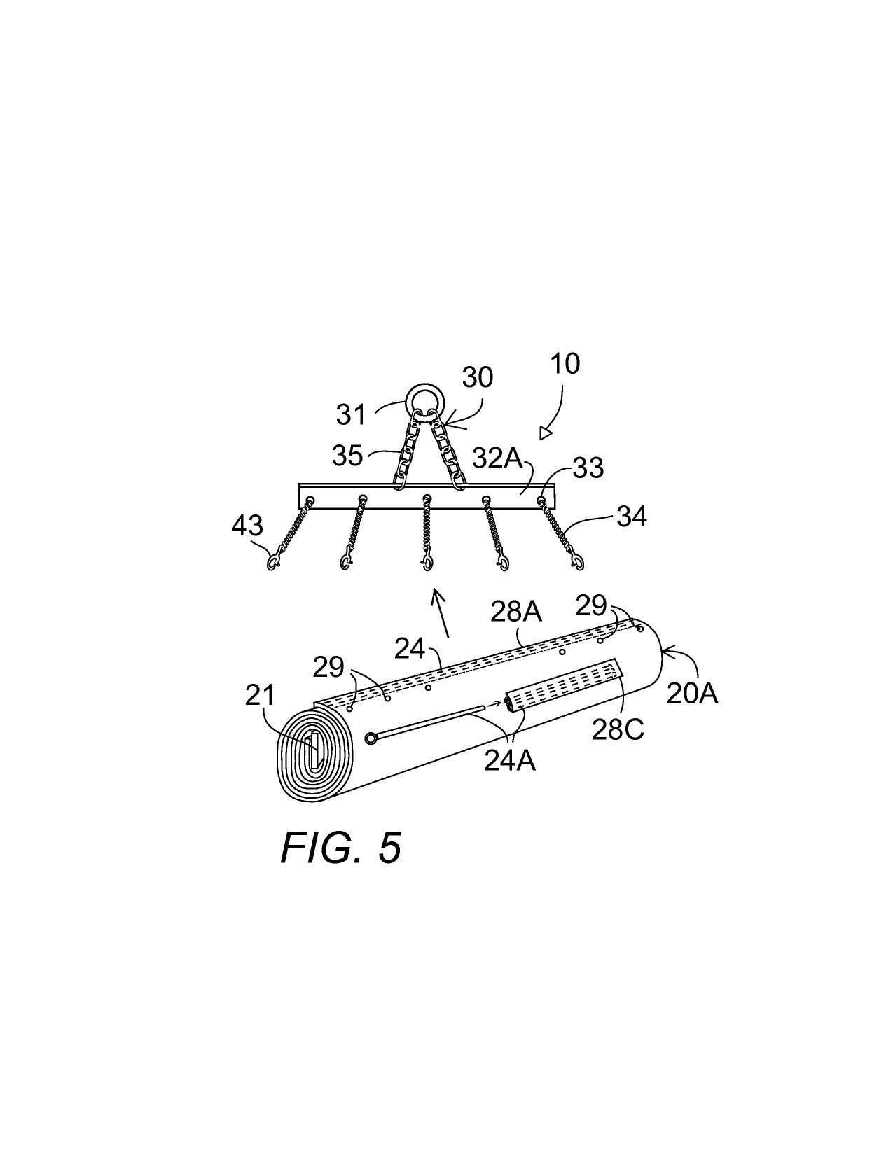

A series of spaced open-ended sleeves 28B are attached to the tarpaulin extending perpendicularly between each adjacent pair of the at least two elongated members 24. A series of removable rigid rods 24A, which may have a finger gripping portion 27, are removably inserted in the spaced sleeves 28B with one of the rigid rods inserted in each of the spaced sleeves during use to assist in maintaining the tarpaulin flat during the first flat position, as shown in FIGS. 1 and 3, for hauling and to maintain the elongated members spaced apart to form a stable tubular funnel shape in the second position, as shown in FIGS. 2 and 4, for emptying the tarpaulin. The hauling rig 30 and the hauling bar 32A and springs 34 with end hooks 43 are removed from the tarpaulin 20 and the rigid rods 24A removed from the tarpaulin 20 to enable rolling up the tarpaulin to form a tarpaulin roll 20A, as shown in FIG. 5, having a length equal to the width of the tarpaulin for storage.

In FIG. 5, an open-ended pocket 28C is attached to the tarpaulin roll aligned parallel to the elongated elements 24 for storing the removable rigid rods 24A so that the hauling tarpaulin rolls up easily and compactly for storage.

In FIG. 2, the device further comprises a cinch tie bag 70 for securing around the funnel tube portion 29 of the tarpaulin with a tight fit for emptying the tarpaulin into the cinch tie bag without spillage. In FIG. 4, a standard tie trash bag 70A is used to collect the contents of the tarpaulin.

The flexible transverse elongated members 24 comprise elongated strips of a synthetic memory material, such as nylon or plastic, having flexibility and are molded in a straight flat position to return the strips to a normal flat position, as shown in FIG. 1, after bending into the funnel tube 29, as shown in FIG. 2.

In use, the tarpaulin 23 is laid flat, as in FIGS. 1 and 3, and loaded with piled leaves or other matter for hauling and the hauling rig 30 attached to a vehicle or, with the extension 40, to a belt 50 on an animal or a person for hauling the loaded tarpaulin which remains flat while being hauled. The back end of the tarpaulin is formed into the tubular funnel shape 29, as shown in FIGS. 2 and 4, which provides a means for easily emptying the tarpaulin in an organized fashion into a bag or other receptacle or into neat piles.

It is understood that the preceding description is given merely by way of illustration and not in limitation of the invention and that various modifications may be made thereto without departing from the spirit of the invention as claimed.

What is claimed is:

1. A tarpaulin hauling device comprising:
a tarpaulin comprising a planar flexible fabric for transporting materials over ground; a semi-rigid edge strip attached to a front edge of the tarpaulin to enable the front edge to travel over the ground smoothly; a rigid forward hauling bar attached to the edge strip on the front edge by a plurality of springs to provide flexibility of movement therebetween so that the front edge of the tarpaulin remains on the ground and the tarpaulin remains flat during towing, the hauling bar spaced apart from and parallel to the front edge of the tarpaulin; a hauling rig attached to the hauling bar to enable the hauling bar to be attached to a moving body to haul the tarpaulin over the ground; at least two flexible elongated members attached transversely across the tarpaulin from a back edge of the tarpaulin forward at spaced intervals and a mating connector at each end of each of each of the elongated members, each of the elongated members being positioned flat on the flat tarpaulin in a first position for maintaining the back of the tarpaulin in a first flat position during loading and hauling the tarpaulin, and each of the elongated members having the two ends of each elongated member connected together to form a circular loop in a second position with the mating connectors at each end removably connected together to form the tarpaulin into a tubular funnel shape at the back of the tarpaulin in the second position for unloading the tarpaulin by pouring the contents through the tubular funnel; a series of spaced open-ended sleeves attached to the tarpaulin extending perpendicularly between each adjacent pair of the at least two elongated members and a series of removable rigid rods removably inserted in the spaced sleeves with one of the rigid rods inserted in each of the spaced sleeves during use to assist in maintaining the tarpaulin flat during the first flat position for hauling and to maintain the elongated members spaced apart to form a stable tubular funnel shape in the second position for emptying the tarpaulin, the hauling rig and the hauling bar and springs removable from the tarpaulin and the rigid rods removable from the tarpaulin to enable rolling up the tarpaulin to form a tarpaulin roll having a length equal to the width of the tarpaulin for storage.

2. The device of claim 1 wherein the edge strip comprises a bar of strong resilient material to sustain hauling a heavy load over the ground while maintaining the integrity of the front edge of the tarpaulin so that the tarpaulin stays flat while being hauled and further comprising a series of spaced grommets along the length for attaching the springs thereto from the towing bar.

3. The device of claim 2 wherein the edge strip is fabricated of at least one strong resilient material taken from the list of strong resilient materials including a strong resilient synthetic material, nylon, flexible plastic, and flexible metal.

4. The device of claim 1 wherein the towing bar comprises a rigid metal bar having a series of spaced openings along the length of the metal bar for receiving the springs and the hauling rig attached to the metal bar, each of the springs further comprising an end hook for removably attaching the spring to one of the series of spaced openings.

5. The device of claim 1 wherein the towing bar comprises a rigid metal angle bar having a series of spaced openings along the length of the metal bar for receiving the springs and the hauling rig attached to the metal bar.

6. The device of claim 1 wherein the flexible transverse elongated members comprise elongated strips of a synthetic memory material having flexibility and are molded in a straight flat position to return the strips to a normal flat position after bending.

7. The device of claim 1 wherein the hauling rig comprises an elongated flexible hauling element having at least one circular ring attached thereto for attaching to a moving body for hauling the tarpaulin.

8. The device of claim 7 wherein the hauling element comprises a chain.

9. The device of claim 7 wherein the circular ring is a rigid steel ring to attach to a moving vehicle for hauling.

10. The device of claim 7 further comprising a hauling rig extension having a circular ring to attach to a belt worn by an animal for hauling.

11. The device of claim 7 further comprising a hauling rig extension having a circular ring to attach to a belt worn by a human for hauling.

12. The device of claim 1 wherein the mating connector at each end of the spaced flexible elongated members comprises a mating toggle cinch and at least one button.

13. The device of claim 1 wherein the mating connector at each end of the spaced flexible elongated members comprises a snap component at one end and at least one mating snap component at another end.

14. The device of claim 1 further comprising a pocket on the tarpaulin roll aligned parallel to the elongated elements for storing the removable rigid rods so that the hauling tarpaulin rolls up easily and compactly for storage.

15. The device of claim 1 further comprising a cinch tie bag for securing around the funnel tube portion of the tarpaulin with a tight fit for emptying the tarpaulin into the cinch tie bag without spillage.
